(19) United States
(12) Patent Application Publication
(10) Pub. No.: US 2017/0374684 A1
(43) Pub. Date: Dec. 28, 2017

(54) IDENTIFIER ASSIGNMENT FOR UNASSOCIATED STATIONS

(71) Applicants: Chittabrata Ghosh, Fremont, CA (US); Jonathan Segev, Tel Mond (IL)

(72) Inventors: Chittabrata Ghosh, Fremont, CA (US); Jonathan Segev, Tel Mond (IL)

(21) Appl. No.: 15/391,531

(22) Filed: Dec. 27, 2016

Related U.S. Application Data
(60) Provisional application No. 62/354,212, filed on Jun. 24, 2016.

(51) Int. Cl. H04W 74/08; H04W 72/04; H04L 29/12; H04L 5/00; H04W 88/08; H04W 84/12

(52) U.S. Cl. CPC H04W 74/0833; H04L 61/6022; H04L 5/0048; H04W 72/044; H04L 5/0007; H04L 5/0055; H04W 84/12; H04W 88/08

(57) ABSTRACT

Methods, apparatuses, computer readable media for identifier assignment for unassociated stations (STAs). An apparatus of a wireless device comprising processing circuitry is disclosed. The processing circuitry configured to: encode a high-efficiency (HE) trigger frame (TF)(HE TF) for uplink (UL) orthogonal frequency division multiple access (OFDMA) random access (RA) including one or more resource units (RUs) for UL OFDMA random access. The processing circuitry may be further configured to decode a packet from a station, the packet including a media access control (MAC) address of the station, and wherein the packet is to be received on a RU of the one or more RUs for UL OFDMA random access, and to encode a response frame comprising a non-associated identification (NAID) for the station and the MAC address of the station.

### PRIORITY CLAIM

This application claims the benefit of priority under 35 USC 119(e) to U.S. Provisional Patent Application Ser. No. 62/354,212, filed Jun. 24, 2016, which is incorporated herein by reference in its entirety.

### TECHNICAL FIELD

Embodiments relate to Institute of Electrical and Electronic Engineers (IEEE) 802.11. Some embodiments relate to high-efficiency (HE) wireless local-area networks (WLANs). Some embodiments relate to IEEE 802.1 lax. Some embodiments relate computer readable media, methods, and apparatuses for identifier assignment for unassociated stations (STAs).

### BACKGROUND

Efficient use of the resources of a wireless local-area network (WLAN) is important to provide bandwidth and acceptable response times to the users of the WLAN. However, often there are many devices trying to share the same resources and the devices may interfere with one another. Additionally, the wireless devices may be moving and the signal quality may be changing. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates a method of identifier assignment for unassociated stations in accordance with some embodiments;

FIG. 3 illustrates a method of identifier assignment for unassociated stations in accordance with some embodiments;

FIG. 4 illustrates an acknowledgement (ACK)/block acknowledgment (BA)/multi-station BA (M-BA) frame in accordance with some embodiments;

FIG. 5 illustrates a ACK/BA/M-BA frame in accordance with some embodiments;

FIG. 6 illustrates a ACK/BA/M-BA frame in accordance with some embodiments;

FIG. 7 illustrates a method of identifier assignment for unassociated stations in accordance with some embodiments;

FIG. 8 illustrates a method of identifier assignment for unassociated stations in accordance with some embodiments;

FIG. 9 illustrates a method of identifier assignment for unassociated stations in accordance with some embodiments;

FIG. 10 illustrates a method of identifier assignment for unassociated stations in accordance with some embodiments; and

FIG. 11 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

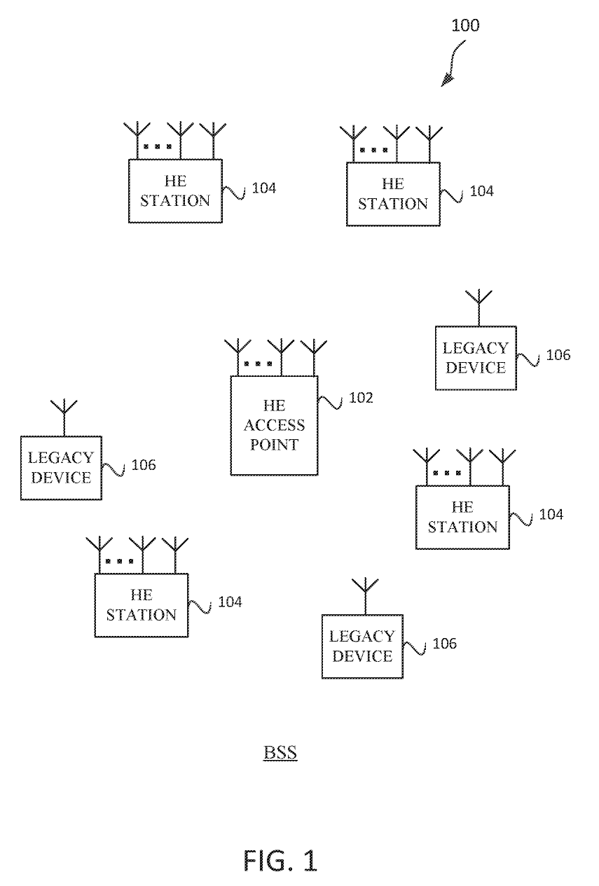

FIG. 1 illustrates a WLAN 100 in accordance with some embodiments. The WLAN 100 may comprise a basis service set (BSS) 100 that may include a HE access point 102, which may be an AP, a plurality of high-efficiency wireless (e.g., IEEE 802.11ax/az) (HE) stations 104, and a plurality of legacy (e.g., IEEE 802.11n/ac) devices 106.

The HE access point 102 may be an AP using the IEEE 802.11 to transmit and receive. The HE access point 102 may be a base station. The HE access point 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one HE access point 102 that is part of an extended service set (ESS). A controller (not illustrated) may store information that is common to the more than one HE access points 102.

The legacy devices 106 may operate in accordance with one or more of IEEE 802.11a/b/g/n/ac/ad/af/ah/aj/ay/az, or another legacy wireless communication standard. The legacy devices 106 may be STAs or IEEE STAs. The HE STAs 104 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE STAs 104 may be termed high efficiency (HE) stations.

The HE access point 102 may communicate with legacy devices 106 in accordance with legacy IEEE 802.11 communication techniques. In example embodiments, the HE access point 102 may also be configured to communicate with HE STAs 104 in accordance with legacy IEEE 802.11 communication techniques.

In some embodiments, a HE frame may be configurable to have the same bandwidth as a channel. The HE frame may be a physical layer convergence procedure (PLCP) protocol data unit (PPDU). In some embodiments, there may be different types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE frame may be configured for transmitting a number of spatial streams, which may be in accordance with MU-MIMO and may be in accordance with OFDMA. In other embodiments, the HE access point 102, HE STA 104, and/or legacy device 106 may also implement different technologies such as code division multiple access (CDMA) 2000, CDMA 2000 IX, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11 embodiments, e.g, IEEE 802.1 lax embodiments, a HE access point 102 may operate as a HE access point which may be arranged to contend for a wireless medium (e.g., during a contention period) to receive exclusive control of the medium for an HE control period. In some embodiments, the HE control period may be termed a transmission opportunity (TXOP). The HE access point 102 may transmit a HE master-sync transmission, which may be a trigger frame or HE control and schedule transmission, at the beginning of the HE control period. The HE access point 102 may transmit a time duration of the TXOP and sub-channel information. During the HE control period, HE STAs 104 may communicate with the HE access point 102 in accordance with a non-contention based multiple access technique such as OFDMA or MU-MIMO. This is unlike conventional WLAN communications in which devices communicate in accordance with a contention-based communication technique, rather than a multiple access technique. During the HE control period, the HE access point 102 may communicate with HE stations 104 using one or more HE frames. During the HE control period, the HE STAs 104 may operate on a sub-channel smaller than the operating range of the HE access point 102. During the HE control period, legacy stations refrain from communicating. The legacy stations may need to receive the communication from the HE access point 102 to defer from communicating.

In accordance with some embodiments, during the TXOP the HE STAs 104 may contend for the wireless medium with the legacy devices 106 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The HE access point 102 may also communicate with legacy stations 106 and/or HE stations 104 in accordance with legacy IEEE 802.11 communication techniques. In some embodiments, the HE access point 102 may also be configurable to communicate with HE stations 104 outside the HE TXOP in accordance with legacy IEEE 802.11 communication techniques, although this is not a requirement.

In some embodiments the HE station 104 may be a “group owner” (GO) for peer-to-peer modes of operation. A wireless device may be a HE station 102 or a HE access point 102.

In some embodiments, the HE station 104 and/or HE access point 102 may be configured to operate in accordance with IEEE 802.11mc. A HE station 104 and/or HE access point 102 may be termed an HE device (e.g., station or AP), if the HE device complies with a wireless communication standard IEEE 802.1 lax.

In some embodiments, the HE stations 104 may have limited power. In some embodiments, the HE stations 104 may have limited power and may transmit on an RU less than 20 MHz in order to reach the HE access point 104.

In example embodiments, the HE station 104 and/or the HE access point 102 are configured to perform the methods and functions described herein in conjunction with FIGS. 1-11.

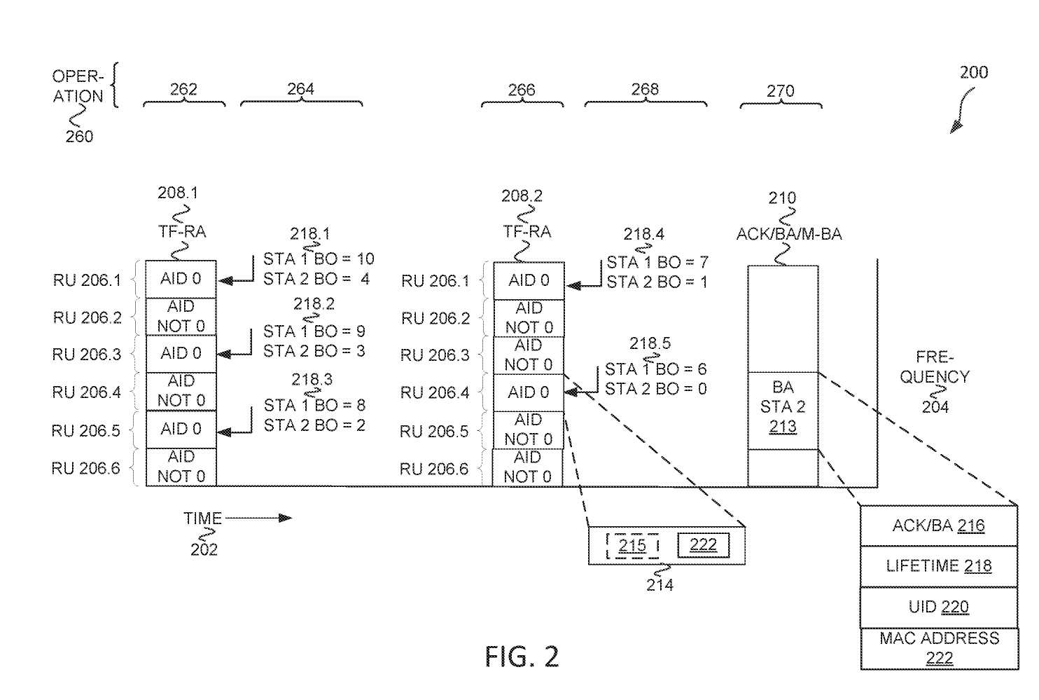

FIG. 2 illustrates a method 200 of identifier assignment for unassociated stations in accordance with some embodiments. Illustrated in FIG. 2 is time 202 along a horizontal axis, frequency 204 along a vertical axis, and operations 260 along the top. The method 200 begins at operation 262 with a trigger frame for random access (TF-RA) 208.1 being transmitted by a HE access point 102 (not illustrated in FIG. 2). The TF-RA 208.1 includes RUs 206 fields for HE stations 104 (not illustrated in FIG. 2). Some of the RUs 206 fields have an association identification (AID) of 0 (e.g., RU 206.3) which indicates that an unassociated HE station 104 may attempt to use the RU indicated by the RU 206 field. Some of the RUs 206 fields have an AID not 0 which indicates that unassociated HE stations 104 may not attempt to use the RU indicated by the RU 206 field. In some embodiments, a different value other than 0 is used to indicate whether the RU 206 field indicates if the RU is for RA.

The method 200 continues at operation 264 with STA1 and STA2 attempting to gain access to an RU. STA1 and STA2 may be HE stations 104. STA1 and STA2 are not associated with the HE access point 102 that transmitted the TFs-RA 208.

STA1 and STA2 may be configured to decrement their backoff (BO) one for each time there is an RU for RA indicated by the value of the RU 206 field. At 218.1, STA1 decrements its BO from 11 to 10, and STA2 decrements it BO from 5 to 4. At 218.2, STA1 decrements its BO from 10 to 9, and STA2 decrements its BO from 4 to 3. At 218.3, STA1 decrements its BO from 9 to 8, and STA2 decrements its BO from 3 to 2. Since the BO of STA1 and STA2 did not reach 0, neither STA1 nor STA2 attempt to transmit.

In some embodiments, STA1 and STA2 access the RUs allocated for random access in a different way. In some embodiments, the BO is termed an OFDMA BO (OBO).

The method 200 continues at operation 266 with the HE access point 102 transmitting TF-RA 208.2. TF-RA 208.2 indicates two RUs that are available for RA. The method 200 continues at operation 264 with STA1 and STA2 attempting to gain access to an RU. At 218.4, STA1 decrements its BO from 8 to 7, and STA2 decrements it BO from 2 to 1. At 218.5, STA1 decrements its BO from 7 to 6, and STA2 decrements its BO from 1 to 0.

STA2 picks up the RU indicated by RU 206.4 since its BO reached zero (0). STA2 transmits frame 214 on the RU indicated by RU 206.4 field. In some embodiments, the TF-RA 208 includes other parameters that indicate how the frame 214 should be transmitted, e.g. a modulation and coding scheme (MCS) and duration. The frame 214 may be limited to a single PPDU, in accordance with some embodiments. In some embodiments, the frame 214 includes a lifetime request 215 field that indicates a requested lifetime for the unique ID (UID) STA2 220. In some embodiments, the frame 214 may be a special frame, a control frame, or another frame that includes a TA field in the MAC header. In some embodiments, the frame 214 may be a management frame with an RA field that permits the RA field to be the TA. In some embodiments, the frame 214 includes a MAC address 222 of STA2.

The method continues at operation 270 with the HE access point 104 transmitting a ACK/BA/M-BA 210. The ACK/BA/M-BA 210 includes an ACK/BA (“BA”) (BA STA 2 213) to acknowledge frame 214. In some embodiments, the BA STA 2 213 is transmitted on the same RU 206.4 that STA2 transmitted frame 214 to the HE access point 102 on. In some embodiments, ACK/BA/M-BA 200 is an ACK/BA/M-BA 400, ACK/BA/M-BA 500, or ACK/BA/M-BA 600. A M-BA indicates the frame may include multiple acknowledgments for multiple stations and multiple TIDs.

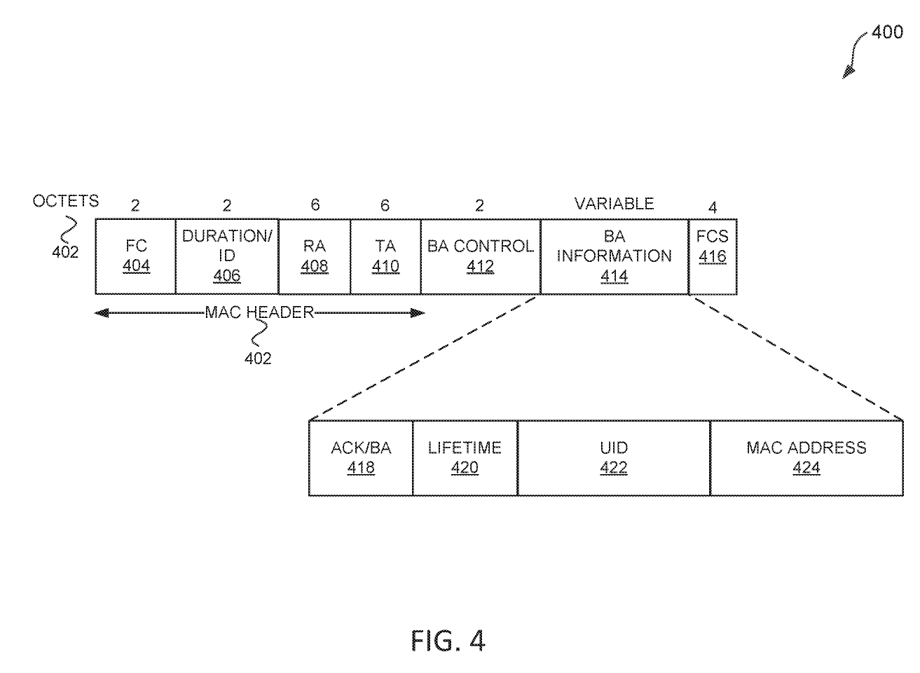

The BA STA2 213 includes UID 220, and, in some embodiments, includes lifetime 218, ACK/BA 216, and/or MAC address 222. In some embodiments, the BA STA2 213 does not include one or more of ACK/BA 216, lifetime 218, and/or MAC address 222. The UID 220, lifetime 218, ACK/BA 216, and MAC address 222 may be as described in conjunction with FIG. 4 with UID 422, lifetime 420, ACK/BA 418, and MAC address 424, respectively. The ACK/BA/M-BA 210 may be an ACK/BA/M-BA 400 as described in conjunction with FIG. 4. The UID 220 is an ID that may be used by STA2 and the HE access point 102 to identify the STA2 in packets. In some embodiments, the UID 220 is termed a non-associated ID (NAID). STA 2 may store the UID 220 and lifetime 218 in a memory of STA 2, e.g., main memory 1004. The UID 220 may have a lifetime after which it expires. In some embodiments, the lifetime is determined by the HE access point 102. In some embodiments, the HE access point 102 transmits the lifetime of the UIDs (e.g., in an information element or field) that may be included in one or more packets, e.g. beacon frames or probe responses. The lifetime 218 may be determined based on a lifetime request 215 from the HE station 104. The lifetime 218 may indicate a duration of the UID 220.

The ACK/BA 216 may be a bit in the BA STA 2 213 that indicates that the frame 214 was received correctly. The ACK/BA 216 may be a bit in the ACK/BA/M-BA 210 that indicates whether the ACK/BA/M-BA 210 is an acknowledgement or a block acknowledgment. In some embodiments, the unassociated HE stations 104 may be limited to one packet to the HE access point 102. In some embodiments, an ACK/BA 216 field is not needed to differentiate between an acknowledgement and a block acknowledgment if there is only one frame 214. The ACK/BA 216 field (e.g., if STA2 is permitted to send only one frame, then only one bit is needed to acknowledge the frame) may be used to indicate to the unassociated HE station 104 that frame 214 was successively received.

The MAC address 222 may be a MAC address of STA2. The HE access point 102 may determine the MAC address of STA2 from the frame 214. The HE access point 102 may include the MAC address of STA2 as MAC address 222. STA2 may verify that the BA STA2 213 is for STA2 based on the MAC address 222 matching the MAC address of STA2.

In some embodiments, including the MAC address of the HE station 104 that transmitted the frame 214 prevents a HE station 104 from mistaking the BA STA2 213 as an acknowledgement of a frame that was transmitted but not received successfully by the HE access point 102. In some embodiments, two or more HE stations 104 may transmit simultaneously on the same RU indicated by the RU 206 field (e.g., both reach a BO of 0 at the same time.) Without the MAC address 222 one or more of the HE stations 104 may mistake the BA STA2 213 as an acknowledgment for their frame (e.g., frame 214) when their frame was not successfully received by the HE access point 102.

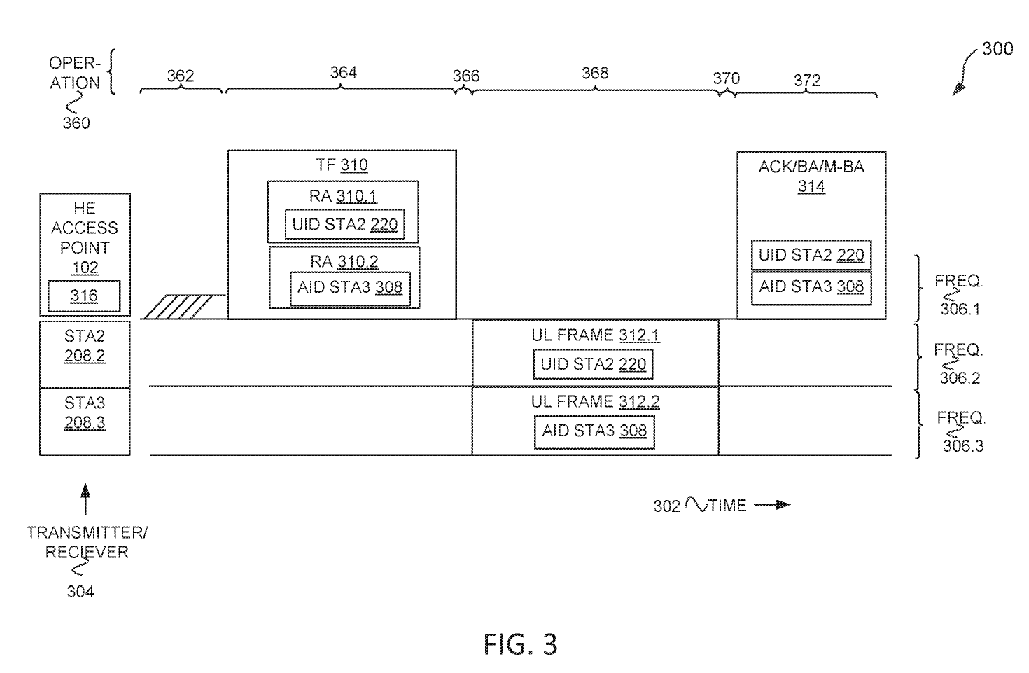

FIG. 3 illustrates a method 300 of identifier assignment for unassociated stations in accordance with some embodiments. Illustrated in FIG. 3 is time 302 along a horizontal axis, transmitter/receiver 304 along a vertical axis, frequency 306 along a vertical axis, and operations 360 along the top. STA2 208.2 may be a HE station 104 that is not associated with the HE access point 102, but has received a UID. STA3 208.3 may be a station that is associated with the HE access point 102. Frequency 306 may indicate a bandwidth that is transmitted and/or received on. The frequencies 306 may overlap with one another. For example, frequency 306.1 may be used by the HE access point 102 to transmit the TF 310, which may be the same frequency 306 as frequency 306.2 and frequency 306.3. Frequencies 306 may be 20 MHz, greater than 20 MHz, or less than 20 MHz, and may be equal to an RU indicated in the TF 310. The frequencies 306 may overlap due to spatial streams, e.g., frequency 306.2 and frequency 306.3 may be the same frequency with different spatial streams. In some embodiments, the HE access point 102 includes information 316 related to fine timing measurements. For example, the HE access point 102 may store information related to STA2 208.2 with UID STA2 312 regarding a context, e.g., number of iterations, consecutive measurements, capabilities, etc. In some embodiments, the STA2 208.2 may transmit service request (SR) frames to the HE access point 102, which may store the information in the information 316.

The method 300 begins at operation 362 with the HE access point 102 gaining access to the wireless medium, e.g., the HE access point 102 may have performed a clear channel assessment (CCA).

The method 300 continues at operation 364 with the HE access point 102 transmitting a TF 310. The TF 310 may include resource allocation (RA) 310.1 for STA2 220 and RA 310.2 for STA3 208.3. The RA 310.1 includes UID STA2 220 that identifies STA2 208.2. The RA 310.2 includes AID STA3 308 that identifies STA3 208.3. The TF 310 may be a trigger frame for fine timing measurements. The RAs 310 may include additional fields for the resource allocation such as a MCS, duration, etc. STA2 208.2 may identify RA 310.1 as being for STA2 208.2 by the UID STA2 220. In some embodiments, the TF 310 may include additional information regarding the UID STA2 220, e.g., it may include additional information regarding a lifetime of the UID STA 220.

The method 300 continues with STA2 208.2 and STA3 208.3 waiting a duration (e.g., short interframe space, SIFS) before transmitting. The method 300 continues at operation 368 with STA2 208.2 transmitting UL frame 312.1 in accordance with the RA 310.1 and with UID STA2 220, and STA3 208.3 transmitting UL frame 312.2 in accordance with RA 310.2 and with AID STA3 308.

The method 300 continues at operation 370 with HE access point 102 waiting a duration, e.g., SIFS, before transmitting. The method 300 continues at operation 372 with HE access point 102 transmitting ACK/BA/M-BA 314 to STA2 208.2 and STA3 208.3. In some embodiments, the portion of the ACK/BA/M-BA 314 for STA2 208.2 is transmitted on the same frequency 306.2 that STA2 208.2 transmitted UL frame 312.1 to the HE access point 102 on. In some embodiments ACK/BA/M-BA 314 is a ACK/BA/M-BA 400, ACK/BA/M-BA 500, or ACK/BA/M-BA 600. The HE access point 102 may determine the UL frame 312.1 is from STA2 208.2 based on the UID STA2 220, and that the UL frame 312.2 is from STA3 208.3 based on AID STA3 308.

The ACK/BA/M-BA 314 acknowledges the successful reception of UL frame 312.1 and UL frame 312.2. In some embodiments, ACK/BA/M-BA 314 may include for STA2 208.2 one or more of ACK/BA 216, lifetime 218, and/or MAC address 222 as described in conjunction with FIG. 2. For example, the ACK/BA/M-BA 314 may include a new lifetime for the UID STA2 220.

FIG. 4 illustrates an acknowledgement (ACK)/block acknowledgment (BA) frame/multi-station BA (M-BA) 400 in accordance with some embodiments. The ACK/BA/M-BA 400 may include a frame control (FC) 404, duration ID 406, receiver address (RA) 408, transmitter address (TA) 410, BA control 412, BA information 414, and FCS 416. The FC 404 may include information about the ACK/BA/M-BA frame 400 such as protocol version, type and subtype fields that identify the type of frame, etc. The duration ID 406 may indicate a duration for the ACK/BA/M-BA frame 400. The RA 408 may indicate a receiver address for the ACK/BA/M-BA frame 400, which may be a broadcast address. The TA 410 indicates the address of the transmitter, which may be the HE access point 102. The FC 404, duration/ID 406, RA 408, and TA 410 may be part of a MAC header 402. The BA control 412 may in include information related to the BA. BA information 414 may include information related to the BA. The FCS 416 may include information that enables error checking and correction.

The BA information 414 may include ACK/BA 418, lifetime 420, UID 422, and MAC address 424. The BA information 414 may include information for multiple stations. The ACK/BA 418 may indicate whether the ACK/BA/M-BA frame 400 is for ACK or BA. In some embodiments, the ACK/BA 418 may indicate for unassociated stations that a single frame was successfully received.

The lifetime 420 may indicate a lifetime for the UID 422. In some embodiments the lifetime 420 is not included in the BA information 414. The lifetime 420 may indicate a duration of the lifetime 420, e.g., in milli seconds, micro seconds, seconds, or minutes. The MAC address 424 may be a MAC address of the station that the ACK/BA/M-BA 400 is for. The UID 422 may be an address for use by a HE access point 104 and HE station 104 to communicate. In some embodiments, UID 422 is a unique ID different from association IDs. In some embodiments, UID 422 is not zero.

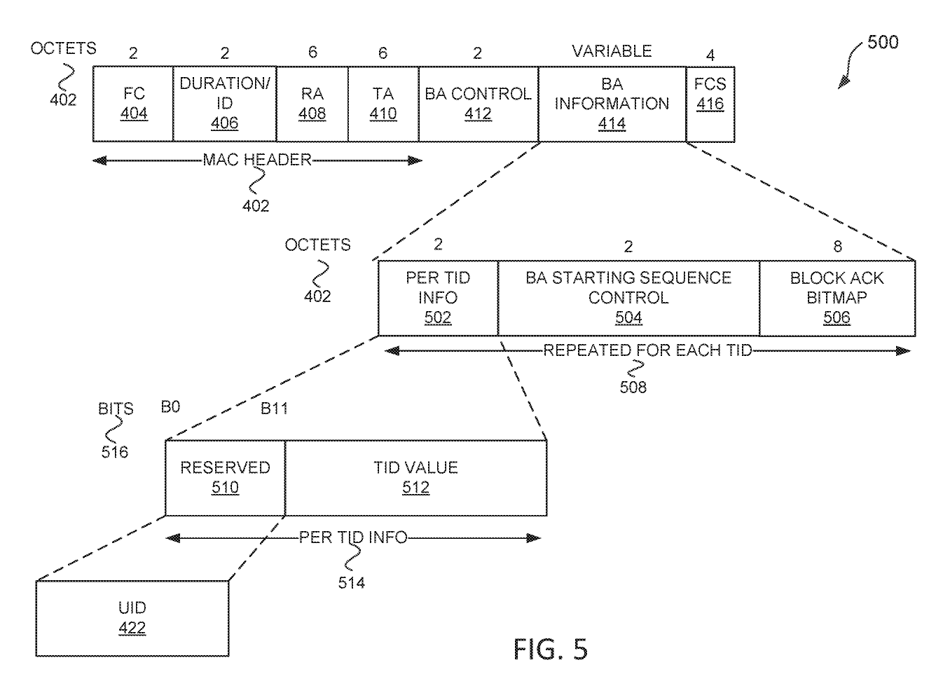

FIG. 5 illustrates a ACK/BA/M-BA frame 500 in accordance with some embodiments. The BA information 414 may include a per traffic ID (TID) information 502 field, BA starting sequence control 504 field, and block ack bitmap 506 field, all three of which may be repeated for each TID 508.

The BA starting sequence control 504 may include the sequence number of the first MAC service data unit (MSDU) for which this ACK/BA/M-BA frame 500 is sent for the corresponding TID. The block ack bitmap 506 may indicate acknowledgements for MSDUs.

The per TID information (INFO) 502 may include reserved 510 and TID value 512. The TID value 512 may include a value for the TID. The reserved 510 may be used for the UID 422. The reserved 510 field may include bits 516 B0 through B11.

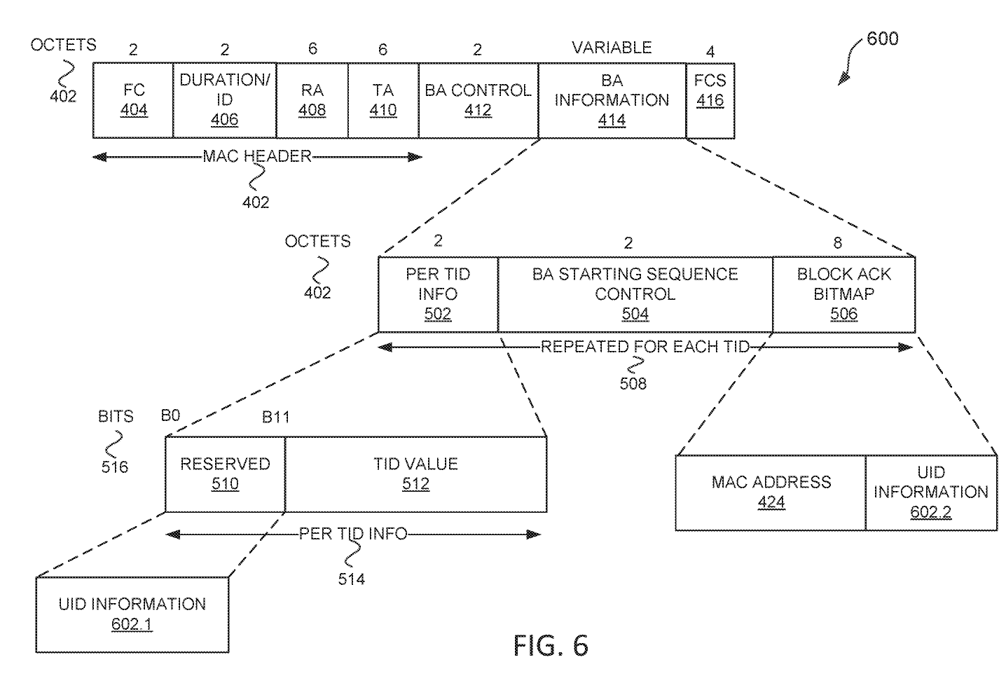

FIG. 6 illustrates a ACK/BA/M-BA frame 600 in accordance with some embodiments. In some embodiments, the MAC address 424 may be represented using the block ack bitmap 506 field. In some embodiments, UID information 602.2 may be represented using the block ack bitmap 506 field. In some embodiments, UID information 602.1 may be represented by the reserved 510 field. UID information 602 may be information related to using UIDs 220, e.g., ACK/BA 216, lifetime 218, UID 220, and/or MAC address 222.

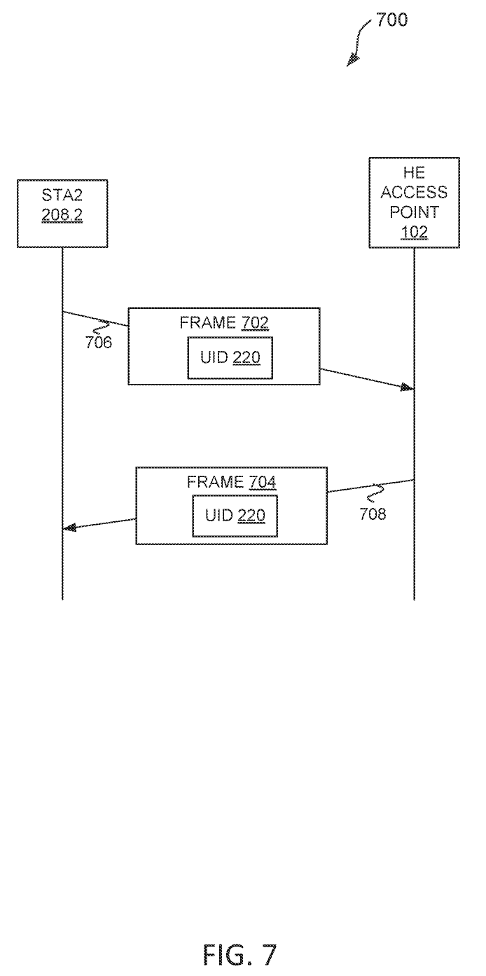

FIG. 7 illustrates a method 700 of identifier assignment for unassociated stations in accordance with some embodiments. Illustrated in FIG. 7 is STA2 208.2 and HE access point 102. The method 700 begins at operation 706 with STA2 208.2 transmitting frame 702 to HE access point 102. The frame 702 includes UID 220. The frame 702 may be a fine timing measurement request, a sensing request, or another frame. The UDI 220 may be used for a single user or MU PPDUs as illustrated in FIG. 7. The frame 702 may include parameters for fine timing measurement, e.g., number of iterations, consecutive measurements, capabilities, etc. The HE access point 102 may store the parameters for fine timing measurement associated with the UID 220. The HE access point 102 may store with UID 220 the lifetime 218 to determine whether the UID 220 is valid or not.

The method 700 continues at operation 708 with the HE access point 102 transmitting a frame 704 to STA2 208.2. Frame 704 may include UID 220. The frame 704 may be a SU or MU PPDU.

The method 700 may continue with other exchanges between STA2 208.2 and the HE access point 102 that use the UID 220 and that may include MU exchanges.

In some embodiments, the frame 702 does not include the UID 220, and the frame 704 includes UID 220 being assigned to the STA2 208.2. Frame 702 and frame 702 may include one or more of lifetime 218 and MAC address 222 as described in conjunction with FIG. 2. In some embodiments, frame 702 or frame 704 initiates a fine timing measurement method.

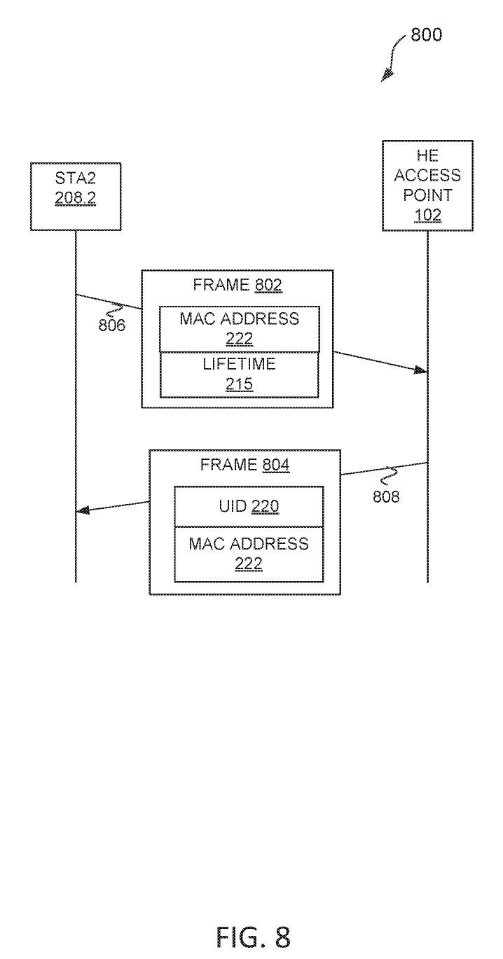

FIG. 8 illustrates a method 800 of identifier assignment for unassociated stations in accordance with some embodiments. Illustrated in FIG. 8 is STA2 208.2 and HE access point 102. The method 800 begins at operation 806 with STA2 208.2 transmitting frame 802 to HE access point 102. The frame 802 includes MAC address 222, and, in some embodiments, lifetime 215. The frame 802 may be a fine timing measurement request, a sensing request, a probe request, or another frame.

The method 800 continues at operation 808 with the HE access point 102 transmitting a frame 804 to STA2 208.2. Frame 804 may include UID 220 and MAC address 222. The frame 804 may be a SU or MU PPDU. The HE access point 102 may determine that the STA2 208.2 is not associated with the HE access point 102 based on frame 802 and allocate a UID 220 for the STA2 208.2. In some embodiments, in response to receiving the frame 802 addressed to the HE access point 102 where the frame is not an association request frame, and a determination that STA2 208.2 is not associated with the HE access point 102, the HE access point 102 determines to allocate a UID 220 for the STA2 802.2.

The method 800 may continue with other exchanges between STA2 208.2 and the HE access point 102 that use the UID 220 and that may include MU exchanges. Frame 804 may include lifetime information for UID 220 as described herein.

In some embodiments, frame 702 or frame 704 initiates a fine timing measurement method.

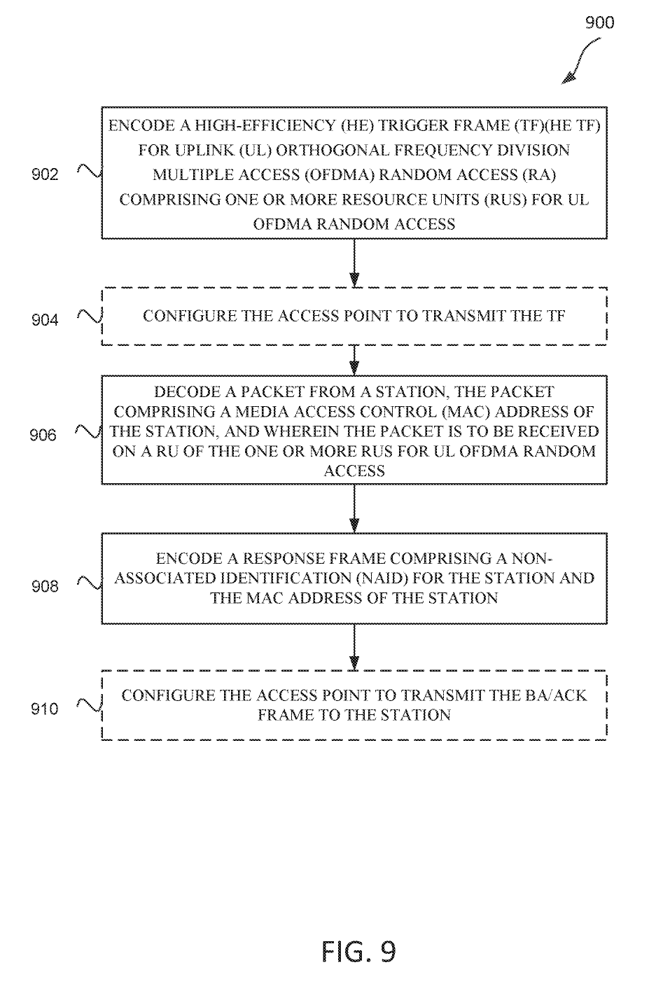

FIG. 9 illustrates a method 900 of identifier assignment for unassociated stations in accordance with some embodiments. The method 900 begins at operation 902 with encoding a HE TF for UL OFDMA RA comprising one or more RUs for UL OFDMA random access. For example, HE access point 102 may encode TF-RA 208.1 or 208.2.

Optionally, the method 900 continues at operation 904 with configuring the access point to transmit the TF RA PPDU. For example, an apparatus of the HE access point 102 may configure the HE access point 102 to transmit the TF-RA 208.1 and/or TF-RA 208.2.

The method 900 continues at operation 906 with decoding a packet from a station, the packet comprising a MAC address of the station, and wherein the packet is to be received on a RU of the one or more RUs for UL OFDMA random access. For example, the HE access point 102 may decode frame 214 from STA2 of FIG. 2 with MAC address 222 of STA2.

The method 900 continues at operation 908 with encoding a response frame comprising a non-associated identification (NAID) for the station and the MAC address of the station. For example, HE station 102 may transmit ACK/BA/M-BA 210 which may include UID 220 and MAC address 222.

Optionally, the method 900 continues at operation 910 with configuring the access point to transmit the BA/ACK frame to the station. For example, an apparatus of the HE access point 102 may configure the HE access point 102 to transmit ACK/BA/M-BA 210.

One or more of the operations of method 900 may be performed by an apparatus of the HE access point 102.

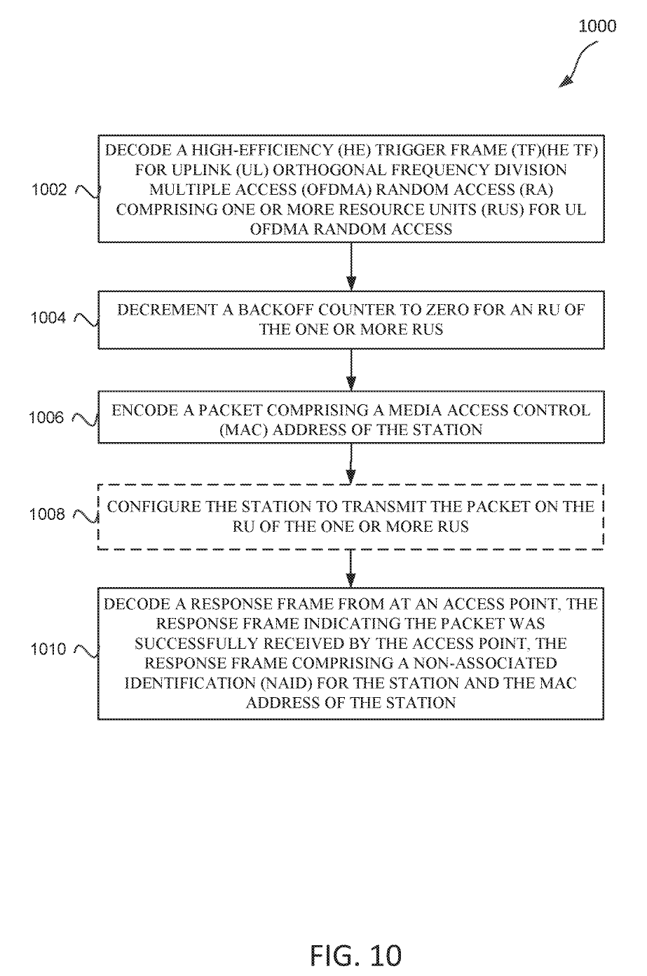

FIG. 10 illustrates a method 1000 of identifier assignment for unassociated stations in accordance with some embodiments. The method 1000 begins at operation 1002 with decoding a HE TF for UL OFDMA RA comprising one or more RUs for UL OFDMA random access. For example, STA2 of FIG. 2 may decode TF-RA 208.2.

The method 1000 continues at operation 1004 with decrementing a backoff counter to zero for an RU of the one or more RUs. For example, STA2 may decrement BO to zero (0) at 218.5.

The method 1000 continues at operation 1006 with encoding a packet comprising a MAC address of the station. For example, STA2 may encode frame 214 including MAC address 222.

Optionally, the method 1000 continues at operation 1008 with configuring the station to transmit the packet on the RU of the one or more RUs. For example, an apparatus of STA2 may configure STA2 to transmit frame 214.

The method 1000 continues at operation 1010 with decoding a response frame from at an access point, the response frame indicating the packet was successfully received by the access point, the response frame comprising a non-associated identification (NAID) for the station and the MAC address of the station.

For example, STA2 may deocde ACK/BA/M-BA 210 which includes MAC address 222 and UID 220. STA2 may confirm that the UID 220 is for STA2 by checking that the MAC address 222 of ACK/BA/M-BA 210 matches the MAC address 222 of frame 214.

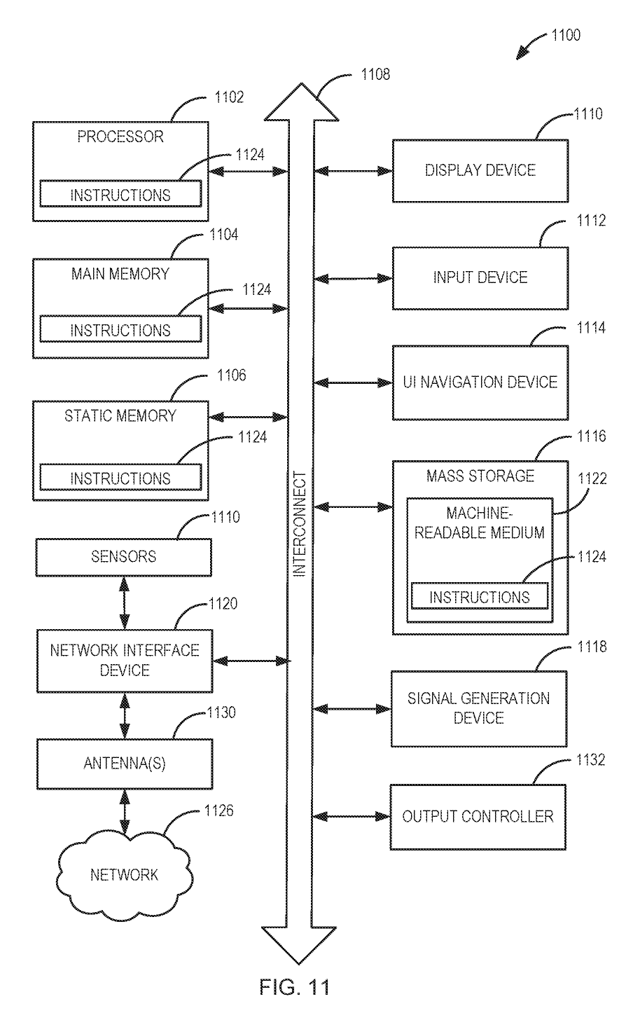

FIG. 11 illustrates a block diagram of an example machine 1100 upon which any one or more of the techniques (e.g., methodologies) discussed herein may perform. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a HE access point 102, HE station 104, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108.

Specific examples of main memory 1104 include Random Access Memory (RAM), and semiconductor memory devices, which may include, in some embodiments, storage locations in semiconductors such as registers. Specific examples of static memory 1106 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1100 may further include a display device 1110, an input device 1112 (e.g., a keyboard), and a user interface (UI) navigation device 1114 (e.g., a mouse). In an example, the display device 1110, input device 1112 and UI navigation device 1114 may be a touch screen display. The machine 1100 may additionally include a mass storage (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 1102 and/or instructions 1124 may comprise processing circuitry and/or transceiver circuitry.

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 1122 is illustrated as a single medium, the term “machine readable medium” may include a single medium or multiple media (e.g., a centralized or distributed database, and/or associated caches and servers) configured to store the one or more instructions 1124.

An apparatus of the machine 1100 may be one or more of a hardware processor 1102 (e.g., a central processing unit (CPU), a graphics processing unit (GPU), a hardware processor core, or any combination thereof), a main memory 1104 and a static memory 1106, sensors 1121, network interface device 1120, antennas 1160, a display device 1110, an input device 1112, a UI navigation device 1114, a mass storage 1116, instructions 1124, a signal generation device 1118, and an output controller 1128. The apparatus may be configured to perform one or more of the methods and/or operations disclosed herein. The apparatus may be intended as a component of the machine 1100 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1120 may include one or more physical jacks (e.g., Ethernet, coaxial, or phone jacks) or one or more antennas to connect to the communications network 1126. In an example, the network interface device 1120 may include one or more antennas 1160 to wirelessly communicate using at least one of single-input multiple-output (SIMO), multiple-input multiple-output (MIMO), or multiple-input single-output (MISO) techniques. In some examples, the network interface device 1120 may wirelessly communicate using Multiple User MIMO techniques. The term “transmission medium” shall be taken to include any intangible medium that is capable of storing, encoding or carrying instructions for execution by the machine 1100, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The following examples pertain to further embodiments. Example 1 is an apparatus of an access point including: a memory; and processing circuitry couple to the memory, where the processing circuitry is configured to: encode a high-efficiency (HE) trigger frame (TF)(HE TF) for uplink (UL) orthogonal frequency division multiple access (OFDMA) random access (RA), the HE trigger frame including one or more resource units (RUs) for UL OFDMA random access; decode a packet from a station, the packet including a media access control (MAC) address of the station, and where the packet is to be received on a RU of the one or more RUs for UL OFDMA random access; and encode a response frame, for transmission to the station, the response frame including a non-associated identification (NAID) for the station and the MAC address of the station.

In Example 2, the subject matter of Example 1 optionally includes where the response frame further comprises a lifetime field, where the value of the lifetime field indicates how long the NAID is valid.

In Example 3, the subject matter of any one or more of Examples 1-2 optionally include where the response frame is a block acknowledgment (BA) frame, an acknowledgement (ACK) frame, or a multi-station BA (M-BA) frame to acknowledge the packet from the station was successfully received by the access point.

In Example 4, the subject matter of any one or more of Examples 1-3 optionally include where the packet from the station further comprises an indication of a requested lifetime for the NAID.

In Example 5, the subject matter of any one or more of Examples 1-4 optionally include where the MAC address of the station is represented in a block acknowledgment information field of the response frame.

In Example 6, the subject matter of any one or more of Examples 1-5 optionally include where the processing circuitry is further configured to: encode a second TF, the second TF including a RU for the station, the station identified by the UAID decode a second packet from the station, the second packet including the UAID, where the second packet is to be received on the RU for the station.

In Example 7, the subject matter of any one or more of Examples 1-6 optionally include where the packet from the station indicates the packet is from a non-associated station.

In Example 8, the subject matter of any one or more of Examples 1-7 optionally include where the processing circuitry is further configured to: encode a beacon frame or probe response frame including a lifetime field indicating a duration for how long the UAID is valid after being assigned to an unassociated station; and configure the access point to transmit the beacon or probe response frame.

In Example 9, the subject matter of any one or more of Examples 1-8 optionally include where the processing circuitry is further configured to: decode a service request frame from the station, the service request (SR) frame including the UAID, and including parameters for fine timing measurement; and configure the access point to store the parameters for fine timing measurement in a memory of the access point associated with the UAID.

In Example 10, the subject matter of Example 9 optionally includes where the processing circuitry is further configured to: perform a fine timing measurement procedure with the station using the parameters for fine timing measurement.

In Example 11, the subject matter of any one or more of Examples 1-10 optionally include where the RU for UL OFDMA random access indicates a bandwidth location and a number of tones for OFDMA.

In Example 12, the subject matter of any one or more of Examples 1-11 optionally include az access point.

In Example 13, the subject matter of any one or more of Examples 1-12 optionally include transceiver circuitry coupled to the memory; and, one or more antennas coupled to the transceiver circuitry.

Example 14 is a non-transitory computer-readable storage medium that stores instructions for execution by one or more processors, the instructions to configure the one or more processors to cause an apparatus of an access point to: decode a packet from a station, the packet including a media access control (MAC) address of the station; determine the station is not associated with the access point based on the packet; in response to receiving the packet addressed to the access point and a determination that the station is not associated with the access point, assign a non-associated identification (NAID) to the station; encode a response frame to the packet including the NAID for the station and the MAC address of the station; and configure the access point to transmit the response frame to the station.

In Example 15, the subject matter of Example 14 optionally includes where the response frame further comprises a lifetime field, where the value of the lifetime field indicates how long the NAID is valid.

In Example 16, the subject matter of any one or more of Examples 14-15 optionally include where the packet from the station is a probe request packet or a fine timing measurement request.

In Example 17, the subject matter of any one or more of Examples 14-16 optionally include where the packet from the station further comprises an indication of a requested lifetime for the NAID.

Example 18 is a method performed by an apparatus of an access point, the method including: encoding a high-efficiency (HE) trigger frame (TF)(HE TF) for uplink (UL) orthogonal frequency division multiple access (OFDMA) random access (RA) including one or more resource units (RUs) for UL OFDMA random access; configuring the access point to transmit the HE TF; decoding a packet from a station, the packet including a media access control (MAC) address of the station, and where the packet is to be received on a RU of the one or more RUs for UL OFDMA random access; encoding a response frame including a non-associated identification (NAID) for the station and the MAC address of the station; and configuring the access point to transmit the response frame to the station.

In Example 19, the subject matter of Example 18 optionally includes where the response frame further comprises a lifetime field, where the value of the lifetime field indicates how long the NAID is valid, and where the response frame is a block acknowledgment (BA) frame, an acknowledgement (ACK) frame, or a multi-station BA (M-BA) frame to acknowledge the packet from the station was successfully received by the access point.

Example 20 is an apparatus of a station including: a memory; and processing circuitry couple to the memory, where the processing circuitry is configured to: decode a high-efficiency (HE) trigger frame (TF)(HE TF) for uplink (UL) orthogonal frequency division multiple access (OFDMA) random access (RA) including one or more resource units (RUs) for UL OFDMA random access; decrement a backoff counter to zero for an RU of the one or more RUs; encode a packet including a media access control (MAC) address of the station; configure the station to transmit the packet on the RU of the one or more RUs; and decode a response frame from at an access point, the response frame indicating the packet was successfully received by the access point, the response frame including a non-associated identification (NAID) for the station and the MAC address of the station.

In Example 21, the subject matter of Example 20 optionally includes where the response frame is a block acknowledgment (BA) frame, an acknowledgement (ACK) frame, or a multi-station BA (M-BA) frame to acknowledge the packet from the station was successfully received by the access point, and where the packet from the station further comprises an indication of a requested lifetime for the NAID.

In Example 22, the subject matter of any one or more of Examples 20-21 optionally include where the processing circuitry is further configured to: encode a second packet including the NAID, the second packet for the access point; and decode a response from the access point, the response including the NAID.

In Example 23, the subject matter of any one or more of Examples 20-22 optionally include where the RU for UL OFDMA random access indicates a bandwidth location and a number of tones for OFDMA.

In Example 24, the subject matter of any one or more of Examples 20-23 optionally include az access point.

In Example 25, the subject matter of any one or more of Examples 20-24 optionally include transceiver circuitry coupled to the memory; and, one or more antennas coupled to the transceiver circuitry.

Example 26 is an apparatus of an access point including: means for encoding a high-efficiency (HE) trigger frame (TF)(HE TF) for uplink (UL) orthogonal frequency division multiple access (OFDMA) random access (RA), the HE trigger frame including one or more resource units (RUs) for UL OFDMA random access; means for decoding a packet from a station, the packet including a media access control (MAC) address of the station, and where the packet is to be received on a RU of the one or more RUs for UL OFDMA random access; and means for encoding a response frame, for transmission to the station, the response frame including a non-associated identification (NAID) for the station and the MAC address of the station.

In Example 27, the subject matter of Example 26 optionally includes where the response frame further comprises a lifetime field, where the value of the lifetime field indicates how long the NAID is valid.

In Example 28, the subject matter of any one or more of Examples 26-27 optionally include where the response frame is a block acknowledgment (BA) frame, an acknowledgement (ACK) frame, or a multi-station BA (M-BA) frame to acknowledge the packet from the station was successfully received by the access point.

In Example 29, the subject matter of any one or more of Examples 26-28 optionally include where the packet from the station further comprises an indication of a requested lifetime for the NAID.

In Example 30, the subject matter of any one or more of Examples 26-29 optionally include where the MAC address of the station is represented in a block acknowledgment information field of the response frame.

In Example 31, the subject matter of any one or more of Examples 26-30 optionally include means for encoding a second TF, the second TF including a RU for the station, the station identified by the UAID; means for decoding a second packet from the station, the second packet including the UAID, where the second packet is to be received on the RU for the station.

In Example 32, the subject matter of any one or more of Examples 26-31 optionally include where the packet from the station indicates the packet is from a non-associated station.

In Example 33, the subject matter of any one or more of Examples 26-32 optionally include means for encoding a beacon frame or probe response frame including a lifetime field indicating a duration for how long the UAID is valid after being assigned to an unassociated station; and means for configuring the access point to transmit the beacon or probe response frame.

In Example 34, the subject matter of any one or more of Examples 26-33 optionally include means for decoding a service request frame from the station, the service request (SR) frame including the UAID, and including parameters for fine timing measurement; and means for configuring the access point to store the parameters for fine timing measurement in a memory of the access point associated with the UAID.

In Example 35, the subject matter of Example 34 optionally includes means for performing a fine timing measurement procedure with the station using the parameters for fine timing measurement.

In Example 36, the subject matter of any one or more of Examples 26-35 optionally include where the RU for UL OFDMA random access indicates a bandwidth location and a number of tones for OFDMA.

In Example 37, the subject matter of any one or more of Examples 26-36 optionally include az access point.

In Example 38, the subject matter of any one or more of Examples 26-37 optionally include means for processing radio frequency signals coupled to means for storing and retrieving data; and, means for receiving and transmitting the radio frequency signals. the transceiver circuitry.

Example 39 is a non-transitory computer-readable storage medium that stores instructions for execution by one or more processors, the instructions to configure the one or more processors to cause an apparatus of a station to: decode a high-efficiency (HE) trigger frame (TF)(HE TF) for uplink (UL) orthogonal frequency division multiple access (OFDMA) random access (RA) including one or more resource units (RUs) for UL OFDMA random access; decrement a backoff counter to zero for an RU of the one or more RUs; encode a packet including a media access control (MAC) address of the station; configure the station to transmit the packet on the RU of the one or more RUs; and decode a response frame from at an access point, the response frame indicating the packet was successfully received by the access point, the response frame including a non-associated identification (NAID) for the station and the MAC address of the station.

In Example 40, the subject matter of Example 39 optionally includes where the response frame is a block acknowledgment (BA) frame, an acknowledgement (ACK) frame, or a multi-station BA (M-BA) frame to acknowledge the packet from the station was successfully received by the access point, and where the packet from the station further comprises an indication of a requested lifetime for the NAID.

In Example 41, the subject matter of any one or more of Examples 39-40 optionally include where the instructions further configure the one or more processors to cause the apparatus of the station to: encode a second packet including the NAID, the second packet for the access point; and decode a response from the access point, the response including the NAID.

In Example 42, the subject matter of any one or more of Examples 39-41 optionally include where the RU for UL OFDMA random access indicates a bandwidth location and a number of tones for OFDMA.

In Example 43, the subject matter of any one or more of Examples 39-42 optionally include az access point.

Example 44 is a method performed by an apparatus of a station, the method including: decoding a high-efficiency (HE) trigger frame (TF)(HE TF) for uplink (UL) orthogonal frequency division multiple access (OFDMA) random access (RA) including one or more resource units (RUs) for UL OFDMA random access; decrementing a backoff counter to zero for an RU of the one or more RUs; encoding a packet including a media access control (MAC) address of the station; configuring the station to transmit the packet on the RU of the one or more RUs; and decoding a response frame from at an access point, the response frame indicating the packet was successfully received by the access point, the response frame including a non-associated identification (NAID) for the station and the MAC address of the station.

In Example 45, the subject matter of Example 44 optionally includes where the response frame is a block acknowledgment (BA) frame, an acknowledgement (ACK) frame, or a multi-station BA (M-BA) frame to acknowledge the packet from the station was successfully received by the access point, and where the packet from the station further comprises an indication of a requested lifetime for the NAID.

In Example 46, the subject matter of any one or more of Examples 44-45 optionally include the method further including: encoding a second packet including the NAID, the second packet for the access point; and decoding a response from the access point, the response including the NAID.

In Example 47, the subject matter of any one or more of Examples 44-46 optionally include where the RU for UL OFDMA random access indicates a bandwidth location and a number of tones for OFDMA.

In Example 48, the subject matter of any one or more of Examples 44-47 optionally include az access point.

Example 49 is an apparatus of a station, the apparatus including: means for decoding a high-efficiency (HE) trigger frame (TF)(HE TF) for uplink (UL) orthogonal frequency division multiple access (OFDMA) random access (RA) including one or more resource units (RUs) for UL OFDMA random access; means for decrementing a backoff counter to zero for an RU of the one or more RUs; means for encoding a packet including a media access control (MAC) address of the station; means for configuring the station to transmit the packet on the RU of the one or more RUs; and means for decoding a response frame from at an access point, the response frame indicating the packet was successfully received by the access point, the response frame including a non-associated identification (NAID) for the station and the MAC address of the station.

In Example 50, the subject matter of Example 49 optionally includes where the response frame is a block acknowledgment (BA) frame, an acknowledgement (ACK) frame, or a multi-station BA (M-BA) frame to acknowledge the packet from the station was successfully received by the access point, and where the packet from the station further comprises an indication of a requested lifetime for the NAID.

In Example 51, the subject matter of any one or more of Examples 49-50 optionally include the apparatus further including: means for encoding a second packet including the NAID, the second packet for the access point; and means for decoding a response from the access point, the response including the NAID.

In Example 52, the subject matter of any one or more of Examples 49-51 optionally include where the RU for UL OFDMA random access indicates a bandwidth location and a number of tones for OFDMA.

In Example 53, the subject matter of any one or more of Examples 49-52 optionally include az access point.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point comprising: a memory; and processing circuitry couple to the memory, wherein the processing circuitry is configured to:
encode a high-efficiency (HE) trigger frame (TF)(HE TF) for uplink (UL) orthogonal frequency division multiple access (OFDMA) random access (RA), the HE trigger frame comprising one or more resource units (RUs) for UL OFDMA random access;
decode a packet from a station, the packet comprising a media access control (MAC) address of the station, and wherein the packet is to be received on a RU of the one or more RUs for UL OFDMA random access; and
encode a response frame, for transmission to the station, the response frame comprising a non-associated identification (NAID) for the station and the MAC address of the station.

2. The apparatus of claim 1, wherein the response frame further comprises a lifetime field, wherein the value of the lifetime field indicates how long the NAID is valid.

3. The apparatus of claim 1, wherein the response frame is a block acknowledgment (BA) frame, an acknowledgement (ACK) frame, or a multi-station BA (M-BA) frame to acknowledge the packet from the station was successfully received by the access point.

4. The apparatus of claim 1, wherein the packet from the station further comprises an indication of a requested lifetime for the NAID.

5. The apparatus of claim 1, wherein the MAC address of the station is represented in a block acknowledgment information field of the response frame.

6. The apparatus of claim 1, wherein the processing circuitry is further configured to:
encode a second TF, the second TF comprising a RU for the station, the station identified by the UAID;
decode a second packet from the station, the second packet comprising the UAID, wherein the second packet is to be received on the RU for the station.

7. The apparatus of claim 1, wherein the packet from the station indicates the packet is from a non-associated station.

8. The apparatus of claim 1, wherein the processing circuitry is further configured to:
encode a beacon frame or probe response frame comprising a lifetime field indicating a duration for how long the UAID is valid after being assigned to an unassociated station; and
configure the access point to transmit the beacon or probe response frame.

9. The apparatus of claim 1, wherein the processing circuitry is further configured to:
decode a service request frame from the station, the service request (SR) frame comprising the UAID, and comprising parameters for fine timing measurement; and
configure the access point to store the parameters for fine timing measurement in a memory of the access point associated with the UAID.

10. The apparatus of claim 9, wherein the processing circuitry is further configured to:
perform a fine timing measurement procedure with the station using the parameters for fine timing measurement.

11. The apparatus of claim 1, wherein the RU for UL OFDMA random access indicates a bandwidth location and a number of tones for OFDMA.

12. The apparatus of claim 1, wherein the access point and the station are each one or more from the following group: an Institute of Electrical and Electronic Engineers (IEEE) 802.11 lax access point, an IEEE 802.11 station, an IEEE access point, a station acting as a group owner (GO), an IEEE 802.11ax station, an IEEE 802.11az station, and an IEEE 802.11 az access point.

13. The apparatus of claim 1, further comprising transceiver circuitry coupled to the memory; and, one or more antennas coupled to the transceiver circuitry.

14. A non-transitory computer-readable storage medium that stores instructions for execution by one or more processors, the instructions to configure the one or more processors to cause an apparatus of an access point to:
decode a packet from a station, the packet comprising a media access control (MAC) address of the station;
determine the station is not associated with the access point based on the packet;
in response to receiving the packet addressed to the access point and a determination that the station is not associated with the access point, assign a non-associated identification (NAID) to the station;
encode a response frame to the packet comprising the NAID for the station and the MAC address of the station; and
configure the access point to transmit the response frame to the station.

15. The non-transitory computer-readable storage medium of claim 14, wherein the response frame further comprises a lifetime field, wherein the value of the lifetime field indicates how long the NAID is valid.

16. The non-transitory computer-readable storage medium of claim 14, wherein the packet from the station is a probe request packet or a fine timing measurement request.

17. The non-transitory computer-readable storage medium of claim 14, wherein the packet from the station further comprises an indication of a requested lifetime for the NAID.

18. A method performed by an apparatus of an access point, the method comprising:
encoding a high-efficiency (HE) trigger frame (TF)(HE TF) for uplink (UL) orthogonal frequency division multiple access (OFDMA) random access (RA) comprising one or more resource units (RUs) for UL OFDMA random access;
configuring the access point to transmit the HE TF;
decoding a packet from a station, the packet comprising a media access control (MAC) address of the station, and wherein the packet is to be received on a RU of the one or more RUs for UL OFDMA random access;
encoding a response frame comprising a non-associated identification (NAID) for the station and the MAC address of the station; and
configuring the access point to transmit the response frame to the station.

19. The method of claim 18, wherein the response frame further comprises a lifetime field, wherein the value of the lifetime field indicates how long the NAID is valid, and wherein the response frame is a block acknowledgment (BA) frame, an acknowledgement (ACK) frame, or a multi-station BA (M-BA) frame to acknowledge the packet from the station was successfully received by the access point.

20. An apparatus of a station comprising: a memory; and processing circuitry couple to the memory, wherein the processing circuitry is configured to:
decode a high-efficiency (HE) trigger frame (TF)(HE TF) for uplink (UL) orthogonal frequency division multiple access (OFDMA) random access (RA) comprising one or more resource units (RUs) for UL OFDMA random access;
decrement a backoff counter to zero for an RU of the one or more RUs;
encode a packet comprising a media access control (MAC) address of the station;
configure the station to transmit the packet on the RU of the one or more RUs; and
decode a response frame from at an access point, the response frame indicating the packet was successfully received by the access point, the response frame comprising a non-associated identification (NAID) for the station and the MAC address of the station.

21. The apparatus of claim 20, wherein the response frame is a block acknowledgment (BA) frame, an acknowledgement (ACK) frame, or a multi-station BA (M-BA) frame to acknowledge the packet from the station was successfully received by the access point, and wherein the packet from the station further comprises an indication of a requested lifetime for the NAID.

22. The apparatus of claim 20, wherein the processing circuitry is further configured to:
encode a second packet comprising the NAID, the second packet for the access point; and
decode a response from the access point, the response comprising the NAID.

23. The apparatus of claim 20, wherein the RU for UL OFDMA random access indicates a bandwidth location and a number of tones for OFDMA.

24. The apparatus of claim 20, wherein the station and the access point each are one or more from the following group: an Institute of Electrical and Electronic Engineers (IEEE) 802.1 lax access point, an IEEE 802.11 station, an IEEE access point, a station acting as a group owner (GO), an IEEE 802.11 ax station, an IEEE 802.11az station, and an IEEE 802.11az access point.

25. The apparatus of claim 20, further comprising transceiver circuitry coupled to the memory; and, one or more antennas coupled to the transceiver circuitry.
